(19) United States
(12) Patent Application Publication
(10) Pub. No.: US 2007/0156671 A1
(43) Pub. Date: Jul. 5, 2007

(54) Category search for structured documents

(76) Inventor: Kai Kut Kenneth Yip, Hong Kong (CN)

Correspondence Address: KNOBBE MARTENS OLSON & BEAR LLP, 2040 MAIN STREET, FOURTEENTH FLOOR, IRVINE, CA, 92614, US

(21) Appl. No.: 11/322,536

(22) Filed: Dec. 30, 2005

(51) Int. Cl. G06F 17/30

(52) U.S. Cl. 707/5

(57) ABSTRACT

A system and a method of performing a category search for a plurality of structured documents which are stored in a database are provided. According to the method, one or more categorization fields of the structured documents and a search query are initially input by a user. A search engine then searches the structured documents according to the search query to obtain a plurality of searched documents. Further, contents of the categorization fields of the searched documents are retrieved by a feeder. The searched documents are then categorized by a categorization engine to obtain categorization results solely based on the contents of the categorization fields of the searched documents. Finally, the categorization results are presented by a reporting engine.

### FIELD OF THE INVENTION

The present invention relates to document searching. More particularly, the present invention relates to a method and system of a category search for structured documents, such as patent documents, company annual reports, financial reports, etc.

### BACKGROUND

Within the realm and spectrum of existing search engines, there are generally two types of search query options: simple search and advanced search. With simple search, a user is presented a single search box including a data entry form known as a text box in which one or more words may be entered. With advanced search, the user is presented with one or more text boxes, and is given instructions on what will happen if the user enters a search word. With some advanced search options, the user is given a drop down menu that instructs the search engine to use certain Boolean operators on whatever words are entered in the text box. Thus, at popular search engines on the Internet, the general search option is simply a blank text box. The advanced search options allow a user to enter words of choice and the search will be conducted on “all the words,” “with any of the words,” as an “exact phrase” or with “none of the words.” The search may also be conducted in any language or in a specified language, of any file format, or of a specific file format, or within some specified time frame.

One recent innovation is a category search which assists users who enter search queries by surveying the indexed listing of web site results and summarizing the topics that the results cover. The Alta Vista Prisma and Vivisimo are examples of search engines and search tools that use this type of technology. These programs analyze and operate on the results of the web search, rather than on the query words themselves.

However, the existing methods of search are not efficient for performing a category search for a plurality of structured documents where one or more categorization fields are specified by the user.

### SUMMARY

A method and a system of performing a category search for a plurality of structured documents which are stored in a database are provided. The structured documents can be patent documents, company annual reports, or financial reports, etc.

According to an aspect of the method, one or more categorization fields of the structured documents and a search query are initially input by a user. The structured documents are then searched according to the search query to obtain a plurality of searched documents. Further, contents of the categorization fields of the searched documents are retrieved. The searched documents are then categorized to obtain categorization results based on the contents of the categorization fields of the searched documents. Finally, the categorization results are presented.

In one embodiment, common words from the contents of the categorization fields of the searched documents are removed prior to categorizing the searched documents.

In one embodiment, plural nouns in the contents of the categorization fields of the searched documents are converted to singular nouns and/or the tense of words in the contents of the categorization fields of the searched documents is converted to present tense prior to categorizing the searched documents.

In one embodiment, links to the searched documents for each of the categorization results are provided.

In one embodiment, translation of the categorization results into one or more different languages is provided.

According to an aspect of the system, a user interface, a database, a search engine, a feeder, a categorization engine, and a reporting engine are included in the system. The user interface is configured to receive one or more categorization fields of the structured documents and a search query input by a user. The database is configured to store the structured documents. The search engine is configured to search the structured documents according to the search query to obtain a plurality of searched documents. The feeder is configured to retrieve contents of the categorization fields of the searched documents. The categorization engine is configured to categorize the searched document to obtain categorization results based on the contents of the categorization fields of the searched documents. The reporting engine is configured to present the categorization results.

In one embodiment, the feeder removes common words from the contents of the categorization fields of the searched documents.

In one embodiment, the feeder converts plural nouns in the contents of the categorization fields of the searched documents to singular nouns and/or converts the tense of words in the contents of the categorization fields of the searched documents to present tense.

In one embodiment, the reporting engine provides links to the searched documents for each of the categorization results.

In one embodiment, the reporting engine provides translation of the categorization results into one or more different languages.

### BRIEF DESCRIPTION OF THE DRAWINGS

FIGS. 1a-1d show portions of a printout of U.S. Pat. No. 6,876,334 from the U.S. Patent and Trademark Office's website.

FIG. 2 is a flowchart showing some stages of conducting a category search.

FIG. 3 is a flowchart showing how a feeder works.

FIG. 4 shows exemplary categorization results of a search query.

### DETAILED DESCRIPTION

Reference is now made in detail to certain embodiments of the invention, examples of which are also provided in the following description. Exemplary embodiments of the invention are described in detail, although it will be apparent to those skilled in the relevant art that some features that are not particularly important to an understanding of the embodiments may not be shown for the sake of clarity.

Furthermore, it should be understood that the invention is not limited to the precise embodiments described below and that various changes and modifications thereof may be effected by one skilled in the art without departing from the spirit or scope of the invention. For example, elements and/or features of different illustrative embodiments may be combined with each other and/or substituted for each other within the scope of this disclosure and appended claims.

Before a category search is conducted, a database for storing structured documents needs to be created. As used herein, the term “category search” refers to grouping search results into categories based on significant words and phrases occurring in the documents, and the term “structured documents” refers to a plurality of documents with a definite format. The structured documents include but are not limited to patents documents, company annual reports, financial reports, etc. The “patent documents” refer to granted patents and/or published patent applications. The database for storing structured documents can be located in a stand-alone computer or a server which is accessible by users via LAN, WAN, Intranet, Internet, etc.

The database for storing structured documents is generally a text-based database. The structure of the database is flexible. For example, the database can be a regular text file containing all the structured documents, separate text files each for a structured document, a relational database in which each record is associated with a structured document, or combination of text file(s) and a relational database. If the database is a regular text file, the information extracted from the structured documents is tagged and imported directly into the text file. The information extracted from each structured document can also be imported into a separate text file. Alternatively, the information extracted from the structured documents can be imported into a relational database. The information extraction process can be performed by parsing the structured documents word by word, line by line, or paragraph by paragraph.

For the relational database, at least one table needs to be generated before the information extraction process is performed. The table generally contains fields that are common items of the structured documents. For example, if the structured documents are U.S. patents, the table may contain the following fields: Patent Number, Patent Granted Date, Patent Title, Abstract, Inventors, Assignee, Application Serial Number, US Filing Date, Current US Class, International Class, Field of Search, US Patent Documents Cited, Other References Cited, Claims, and Description. More fields, such as Related Application Data, Examiner, Attorney, Attorney or Firm, etc. can also be added to the table.

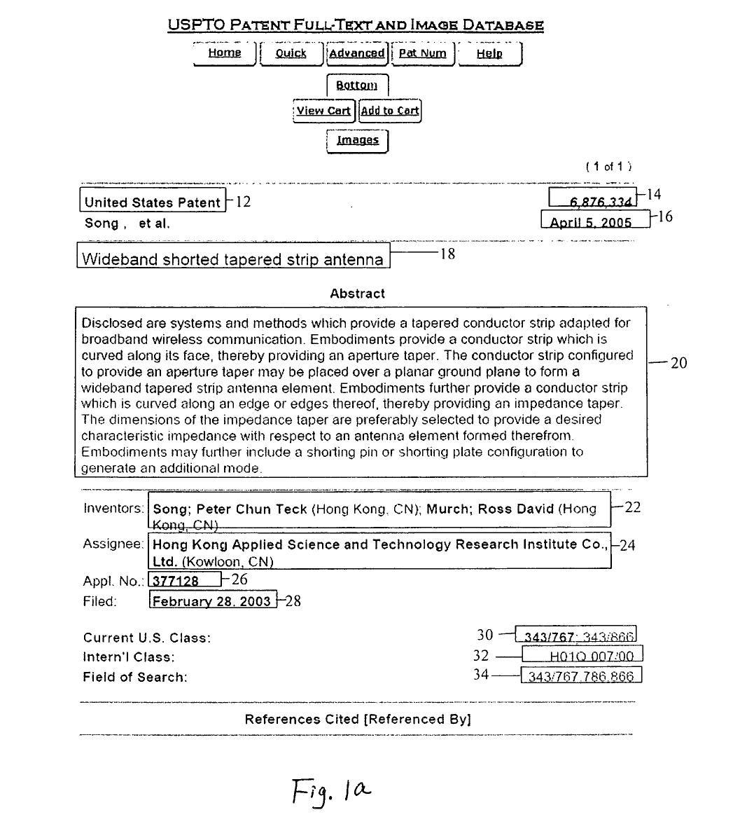

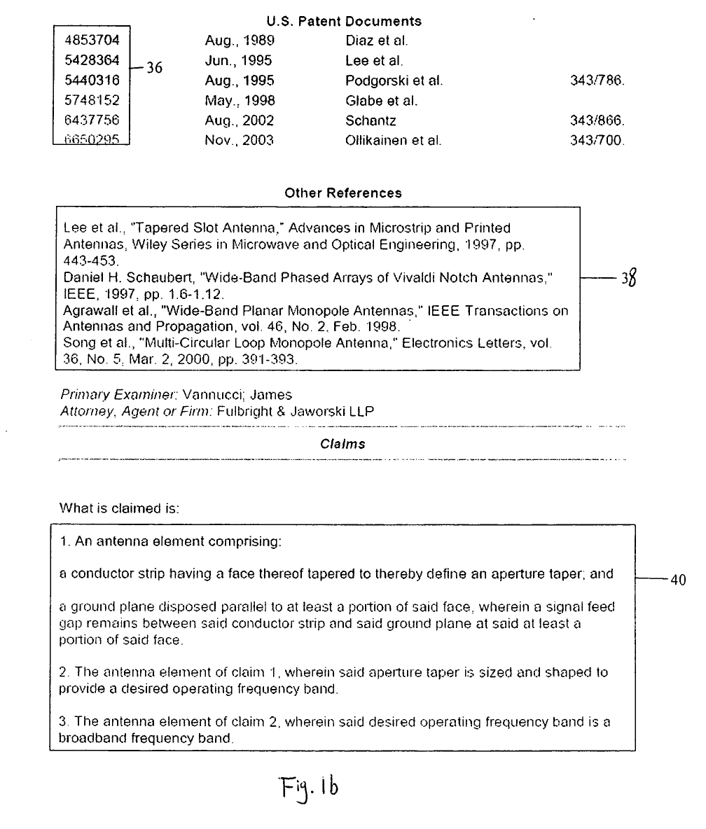

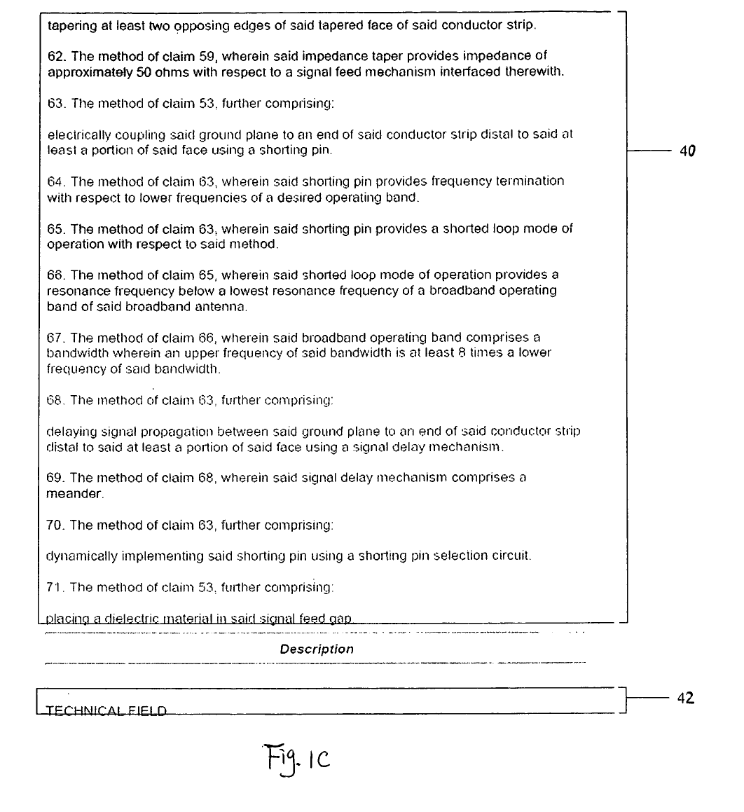

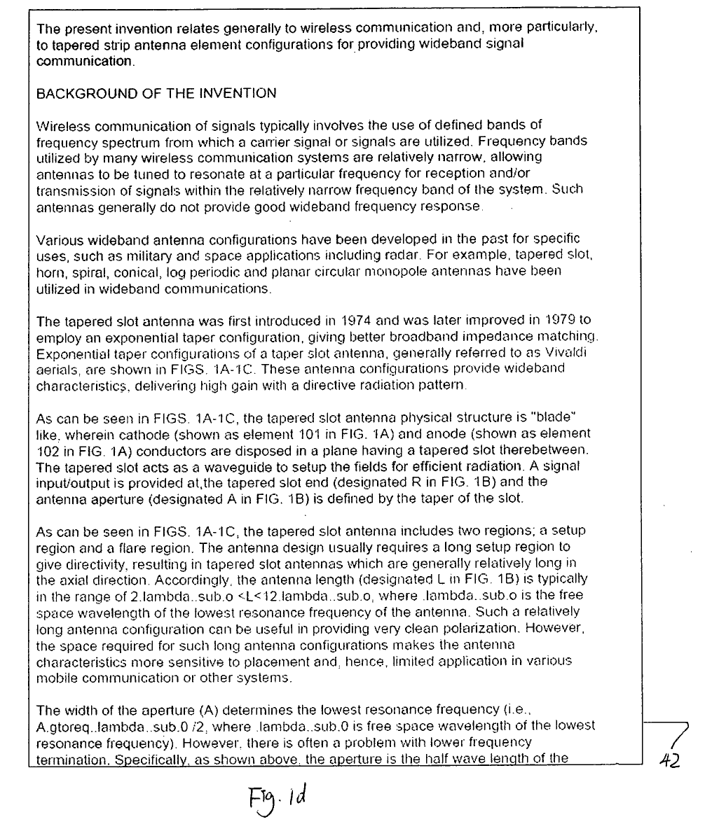

FIGS. 1a-1d show portions of a printout (HTML file) of an exemplary issued U.S. patent, U.S. Pat. No. 6,876,334 (the '334 patent), from the U.S. Patent and Trademark Office (USPTO)'s website. The steps of extracting information from the '334 patent and importing it into the database are described below:

Step 1: Initiating a new record in the database described above.

Step 2: Downloading a HTML file of the '334 patent from the USPTO's website.

Step 3: Removing all HTML tags of the file.

Step 4: Removing any content before item 12—“United States Patent.”

Step 5: Importing item 14—“U.S. Pat. No. 6,876,334” into the “Patent Number” field of the record.

Step 6: Importing item 16—“Apr. 5, 2005” into the “Patent Granted Date” field of the record.

Step 7: Importing item 18—“Wideband shorted tapered strip antenna” into the “Patent Title” field of the record.

Step 8: Importing the whole contents of the Abstract of the '334 patent listed in Item 20 into the “Abstract” field of the record.

Step 9: Importing item 22—“Song; Peter Chun Teck (Hong Kong, CN); Murch; Ross David (Hong Kong, CN)” into the “Inventors” field of the record.

Step 10: Importing item 24—“Hong Kong Applied Science and Technology Research Institute Co., Ltd. (Kowloon, Conn.)” into the “Assignee” field of the record.

Step 11: Importing item 26—“377128” into the “Application Serial Number” field of the record.

Step 12: Importing item 28—“Feb. 28, 2003” into the “US Filing Date” field of the record.

Step 13: Importing item 30—“343/767; 343/866” into the “Current US Class” field of the record.

Step 14: Importing item 32—“H01Q 007/00” into the “International Class” field of the record.

Step 15: Importing item 34—“343/767,786,866” into the “Field of Search” field of the record.

Step 16: Importing all of the U.S. patent numbers listed in Item 36 into the “US Patent Documents Cited” field of the record.

Step 17: Importing all of the other references listed in Item 38 into the “Other References Cited” field of the record.

Step 18: Importing all of the claims listed in Item 40 into the “Claims” field of the record. (FIGS. 1b and 1c only show partial contents of the “Claims” field.)

Step 19: Importing the whole contents after the term “Description” listed in Item 42 into the “Description” field of the record. (FIG. 1d only shows partial contents of the “Description” field.)

By going through steps 1 to 19, a record for the '334 patent is created in the database. The database can contain all granted U.S. patents if the capacity of the database permits. Although the method of extracting information from a granted U.S. patent and importing it into a database is described herein, it is to be understood that information of published U.S. patent applications, granted patents or published patent applications of other countries, and published PCT patent applications can also be extracted and imported into the same database or different databases for later category searches. It is also to be understood that, for other structured documents such as company annual reports, financial reports, etc., the same information extraction mechanism can be performed to build a database for later category searches.

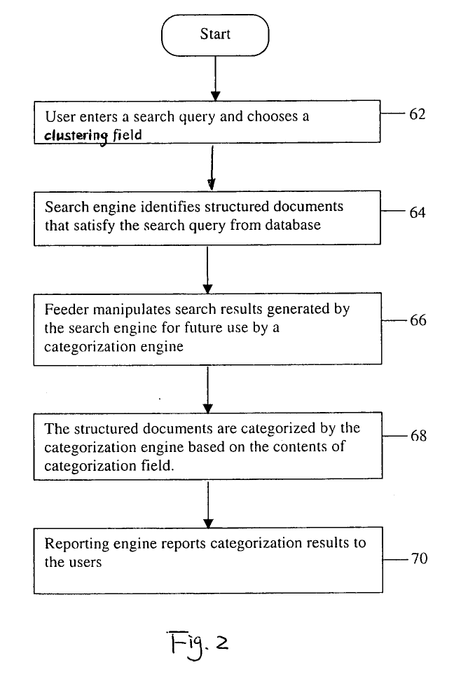

FIG. 2 is a flowchart showing some steps of conducting a category search. Initially, the user inputs a search query and chooses a categorization field to perform the category search, as illustrated in step 62. The search query generally contains one or more keywords. If two or more keywords are in the query, one or more logic or database operators (e.g., Boolean operators and SQL commands) are used to connect the keywords. The categorization field refers to a common field of the structured documents where the categorization or grouping is performed based on the contents in the common field. For example, the categorization field of patent documents can be “Abstract,” “Claims,” “Assignee,” “international class,” etc. It is to be understood that more categorization fields can be chosen when conducting a category search.

In step 64, the search engine identifies the structured documents that satisfy the search criteria of the query from the database. It is to be understood that any kind of search engine can be used to perform the search, as long as the search engine can find the documents that satisfy the search criteria.

A simple search engine that can be used is one that goes through the database word by word to locate the keywords input by the user. Once the search engine finds a document that satisfies the search criteria, in one embodiment, the search engine can report the document's record number (e.g., the location of the document in the database) to a feeder for further handling. (The details of the feeder are described below.) For example, if the search criteria is to look for all patents invented by “Peter Song,” the search engine reports the record number of the '334 patent in the database to the feeder. Although reporting the document's record number to the feeder is described herein, it is to be understood that other methods can be used to notify the feeder of the identified documents. For example, the feeder can identify a document according to the document's title, filename or path.

A more sophisticated search engine, such as Lucene—a Java-based open source toolkit for text indexing and searching, allows a user to enter complicated search queries. For example, a user can enter a query that searches for the term “conductor” only in the “Claims” field. Lucene will only look for the term “conductor” in the “Claims” field of each record, but skip other fields. The '334 patent satisfies the search criteria of the query. As a result, Lucene identifies the record number of the '334 patent in the database. If the user looks for the term “conductor” in the “Patent Title” field, the '334 does not satisfy the search criteria of the query. As a result, Lucene does not identify the record number of the '334 patent in the database. After the search engine identifies all documents that satisfy the search criteria in the database, the record numbers of these documents are then reported to the feeder. The feeder is a software program that manipulates search results generated by the search engine for future use by a categorization engine (step 66). Some advanced search engines can modify the search query by including more related words. For example, to search for the term “conductor,” an advanced search engine may include “conduct,” “conducts,” “conducting” and “conducted” into the search query. Although reporting the document's record number to the feeder is described herein, it is to be understood that other methods can be used to notify the feeder of the identified documents. For example, the feeder can identify a document according to the document's title, filename or path.

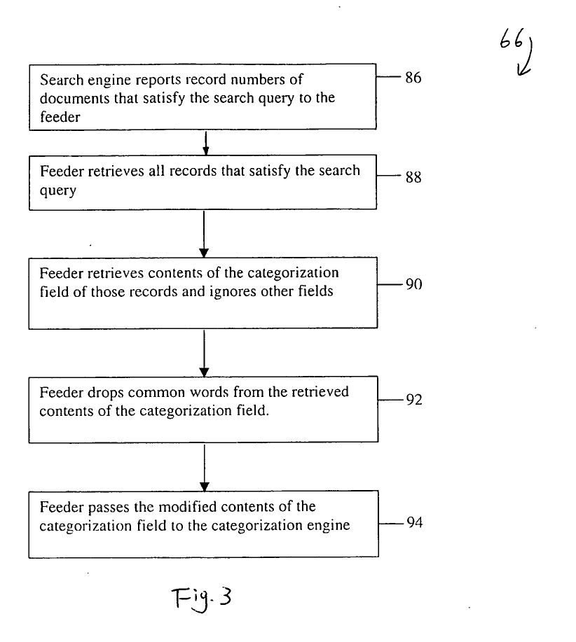

Referring now to FIG. 3, a flowchart shows how the feeder 66 works. In one embodiment, after the search engine reports the record numbers of the documents that satisfy the search criteria of the query to the feeder (step 86), the feeder may retrieve all the records that satisfy the search criteria of the query (step 88). Further, the feeder retrieves the contents of the categorization field of those records and ignores other fields as shown in step 90. For example, if a user instructs the system to categorize patent documents based on the contents of the “Abstract” field (i.e., the categorization field), only the contents of the “Abstract” field are retrieved and passed to the categorization engine. The contents in other fields of the records, such as “Patent Title,” “Inventors,” “Claims,” etc. are ignored. Ignoring other fields reduces the size of contents to be analyzed. As a result, less computing resources are required and faster computation speed can be achieved.

The feeder may remove common words from the retrieved contents of the categorization field (step 92). As used herein, the “common words” refer to words or phrases that frequently appear in the structured documents. For annual report documents, the common words include “revenue,” “profit,” “income,” “market,” etc. For patent documents, the common words include “method,” “apparatus,” “said,” “wherein,” “comprising,” “consisting,” “means,” etc. The common words may also include words that frequently appear in all kinds of documents, including structured documents. For English documents, the common words include “a,” “an,” “the,” “on,” “in,” “at,” “and,” etc. The feeder may also remove punctuations from the retrieved contents of the categorization field. Below is a table showing exemplary common words for patents and regular English documents, which can be removed by the feeder.

| | Common words for | | |
|---|---|---|---|
| Common words for patens: | regular English documents | | |
| allow | about | if | said |
| allows | abs | into | same |
| apparatus | accordingly | is | seem |
| apparatus for control | affected | it | seen |
| body | affecting | itself | several |
| combined | after | just | shall |
| comprises | again | keep | should |
| comprising | against | kept | show |
| conform | all | kg | showed |
| connected | almost | knowledge | shown |
| consisting | already | largely | shows |
| constituted | also | like made | significantly |
| continued | although | mainly | similar |
| control method | always | make | similarly |
| corresponding | among | many | since |
| described | an | mg | slightly |
| device | and | might | so |
| disclosed | any | ml | some |
| element | anyone | more | sometime |
| element formed | apparently | most | somewhat |
| elements | are | mostly | soon |
| function | arise | much | specifically |
| include | as | must | state |
| includes | aside | nearly | states |
| including | at | necessarily | strongly |
| invention | away | neither | substantially |
| making | be | next | successfully |
| means | became | none | such |
| measured | because | nor | sufficiently |
| method | become | normally | than |
| mounted | becomes | not | that |
| present | been | noted | the |
| producing | before | now | their |
| provided | being | obtain | theirs |
| providing | between | obtained | them |
| relate | both | of | then |
| relates | briefly | often | there |
| selected | but | only | therefore |
| serves | by | or | these |
| set forth | came | other | they |
| structure | can | our | this |
| thereon | cannot | out | those |
| use | certain | owing | though |
| used | certainly | particularly | through |
| | could | past | throughout |
| | does | perhaps | to |
| | done | please | too |
| | during | poorly | toward |
| | each | possible | under |
| | either | possibly | unless |
| | else | potentially | until |
| | etc | predominantly | upon |
| | ever | previously | usefully |
| | every | primarily | usefulness |
| | following | probably | using |
| | for | prompt | usually |
| | found | promptly | various |
| | from | put | very |
| | further | quickly | was |
| | gave | quite | we |
| | gets | rather | were |
| | give | readily | what |
| | given | really | when |
| | giving | recently | where |
| | gone | refs | whether |
| | got | regarding | which |
| | had | regardless | while |
| | hardly | relatively | who |
| | has | respectively | whose |
| | have | resulted | why |
| | having | resulting | widely |
| | here | results | will |
| | how | | with |
| | however | | within |
| | | | without |
| | | | would |
| | | | yet |

Taking claim 1 of the '334 patent as an example, the claim recites “[a]n antenna element comprising a conductor strip having a face thereof tapered to thereby define an aperture taper; and a ground plane disposed parallel to at least a portion of said face, wherein a signal feed gap remains between said conductor strip and said ground plane at said at least a portion of said face.” The common words to remove for claim 1 are “element,” “comprising,” “thereof,” “wherein,” “said,” an, “a,” “having,” “to,” “an,” “and,” “at least,” “of” and “between.” As a result, claim 1 becomes “antenna conductor strip face tapered define aperture taper ground plane disposed parallel portion face signal feed gap remains conductor strip ground plane portion face” after removing the common words and punctuations by the feeder. The removal of common words reduces the amount of contents to be analyzed by the categorization engine, which results in higher computational efficiency and accuracy.

The following is an exemplary syntax of the feeder which is used to remove the common words:

```
For counter1=1 to all_sentences_in_the_content {
  For counter2=1 to total_number_of_common_words_in_the
common_word_list {
    focused_common_word = common_word_list[counter2];
    If the current sentence, all_sentences_in_the_content [counter1],
  has the focused_common_word, replace the focused_common_word
    with space;
    increase counter2;
  }
    increase counter1;
}
```

The feeder can also be improved by converting plural nouns to singular nouns and/or converting the tense of words to the present tense. As a result, claim 1 becomes “antenna conductor strip face taper define aperture taper ground plane dispose parallel portion face signal feed gap remain conductor strip ground plane portion face” after converting plural nouns to singular nouns and converting the tense of the words to the present tense.

Finally, the feeder passes the modified contents of the categorization field of the records to the categorization engine for further handling as shown in step 94.

Referring back to FIG. 2, in step 68, the structured documents are categorized by the categorization engine based on the contents of the categorization field. The categorization engine is a software program that groups the search results. Many existing categorization engines, such as Carrot² or Visimo, can be used to perform step 68 of the category searches. For different categorization engines, the feeder is modified to satisfy different input requirements (such as data structure and text format) of the categorization engines. In some embodiments, the feeder may reformat the contents received from the search engine for the categorization engine. For example, the categorization engine may require an XML format input or an SQL format input. Accordingly, a software program is used to customize the input format according to the criteria defined by the categorization engine.

Once the structured documents are categorized based on the contents of the categorization field, the categorization results are passed to a reporting engine. As used herein, the “categorization results” refer to one or more significant terms occurring in the contents of the categorization field of the structured documents. The significance of a term can be measured in many perspectives, depending on the user's preference, industry norm and/or the categorization engine vendor's experience. For example, the significance of the term can be measured by (1) the number of occurrence of the term, (2) location of the term, such as at the beginning or at the end of a sentence, (3) joint probability of the occurrence of the term with other terms, (4) the number of words in the term, (5) other measures, or (6) any combination of (1) to (5). The categorization results are usually in the format of a word or a phrase.

The reporting engine is a software program that generates reports for the users from the categorization results. The reporting engine can report the categorization results to the user in a user-friendly format as shown in step 70. There is no definite format on how the reporting engine should report the categorization results. For example, the output of the categorization results can be in text format with statistical information. The user can have freedom to decide how the text and statistical information be displayed.

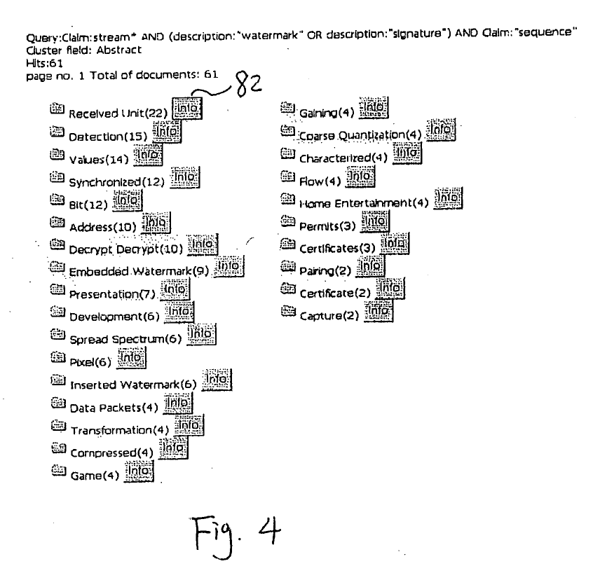

FIG. 4 shows exemplary categorization results of a search query. In this example, the search query is Claim: stream* AND (description: “watermark” OR description: “signature”) AND Claim: “sequence,” and the categorization field is “Abstract.” The search engine finds 61 patents that satisfy the search criteria of this query. The categorization results determined by the categorization engine are “Received Unit,” “Detection,” “Values,” etc. The number in a bracket beside each categorization result indicates the number of patents among the 61 patents that falls into that categorization result. For example, among the 61 patents, 22 patents that satisfy the search criteria of the query contain the phrase “Received Unit” in their Abstracts. The reporting engine also provides links to the documents for each of the categorization results. For example, when the user click the button 82 marked “info,” all 22 patents will be displayed.

Optionally, the reporting engine can translate the categorization results created by categorization engine into different languages.

The category search can be conducted in each categorization result until the number of structured documents of each categorization result is smaller than a threshold number. The threshold number can be defined by the user or pre-defined by a default value. For example, when the user inputs a search query into the search engine, the search engine finds a number of documents (e.g., 1000 documents) that satisfy the search criteria of the query. Among these 1000 documents, the categorization engine categorizes them into a few categorization results (e.g., 10 categorization results) in a categorization field. Each of these categorization results is shown in a number of documents (e.g., 100 documents). However, the documents in one categorization result may be further categorized into more categorization results, such as another five categorization results each with 20 documents. If the user sets the threshold number to be 30 documents, there will be no further categorizing for these 20 documents. On the other hand, if the threshold number is set to be 10 documents, the categorizing will continue.

Although the present invention has been described with reference to preferred embodiments, workers skilled in the art will recognize that changes may be made in form and detail without departing from the spirit and scope of the invention. In addition, the embodiments are not to be taken as limited to all of the details thereof as modifications and variations thereof may be made without departing from the spirit or scope of the invention.

I claim:

1. A method of performing a category search for a plurality of structured documents stored in a database, the method comprising:
(A) receiving one or more categorization fields of the structured documents and a search query input by a user;
(B) searching the structured documents according to the search query to obtain a plurality of searched documents;
(C) retrieving contents of the one or more categorization fields of the searched documents;
(D) categorizing the searched documents to obtain categorization results based on the contents of the one or more categorization fields of the searched documents; and
(E) presenting the categorization results.

2. The method of claim 1 further comprising removing common words from the contents of the categorization fields of the searched documents prior to act (D).

3. The method of claim 1 further comprising converting plural nouns in the contents of the categorization fields of the searched documents to singular nouns and/or converting the tense of words in the contents of the categorization fields of the searched documents to present tense prior to act (D).

4. The method of claim 1 wherein act (E) comprises providing links to the searched documents for each of the categorization results.

5. The method of claim 1 wherein act (E) comprises providing translation of the categorization results into one or more different languages.

6. The method of claim 1 wherein the structured documents are patent documents, company annual reports, or financial reports.

7. A method of performing a category search for a plurality of structured documents stored in a database, the method comprising:
(A) receiving one or more categorization fields of the structured documents and a search query input by a user;
(B) searching the structured documents according to the search query to obtain a plurality of searched documents;
(C) retrieving contents of only the one or more categorization fields of the searched documents;
(D) removing common words from the contents of the one or more categorization fields of the searched documents;
(E) obtaining categorization results based on the contents of the one or more categorization fields of the searched documents; and
(F) presenting the categorization results and providing links to the searched documents for each of the categorization results.

8. The method of claim 7 further comprising converting plural nouns in the contents of the categorization fields of the searched documents to singular nouns and/or converting the tense of words in the contents of the categorization fields of the searched documents to present tense prior to act (E).

9. The method of claim 7 wherein act (F) comprises providing translation of the categorization results into one or more different languages.

10. The method of claim 7 wherein the structured documents are patent documents, company annual reports, or financial reports.

11. A system of performing a category search for a plurality of structured documents, the system comprising:
(A) a user interface configured to receive one or more categorization fields of the structured documents and a search query input by a user;
(B) a database configured to store the structured documents;
(C) a search engine configured to search the structured documents according to the search query to obtain a plurality of searched documents;
(D) a feeder configured to retrieve contents of the one or more categorization fields of the searched documents;
(E) a categorization engine configured to categorize the searched document to obtain categorization results based on the contents of the one or more categorization fields of the searched documents; and
(F) a reporting engine configured to present the categorization results.

12. The system of claim 11 wherein the feeder removes common words from the contents of the categorization fields of the searched documents.

13. The system of claim 1 I wherein the feeder converts plural nouns in the contents of the categorization fields of the searched documents to singular nouns and/or converts the tense of words in the contents of the categorization fields of the searched documents to present tense.

14. The system of claim 11 wherein the reporting engine provides links to the searched documents for each of the categorization results.

15. The method of claim 11 wherein the reporting engine provides translation of the categorization results into one or more different languages.

16. The system of claim 11 wherein the structured documents are patent documents, company annual reports, or financial reports.

17. A system of performing a category search for a plurality of structured documents, the system comprising:
(A) a user interface configured to receive one or more categorization fields of the structured documents and a search query input by a user;
(B) a database configured to store the structured documents;
(C) a search engine configured to search the structured documents according to the search query to obtain a plurality of searched documents;
(D) a feeder configured to retrieve contents of the one or more categorization fields of the searched documents and to remove common words from the contents of the one or more categorization fields of the searched documents;
(E) a categorization engine configured to obtain categorization results solely based on the contents of the one or more categorization fields of the searched documents; and
(F) a reporting engine configured to present the categorization results and to provide links to the searched documents for each of the categorization results.

18. The system of claim 17 wherein the feeder converts plural nouns in the contents of the categorization fields of the searched documents to singular nouns and/or converts the tense of words in the contents of the categorization fields of the searched documents to present tense.

19. The method of claim 17 wherein the reporting engine provides translation of the categorization results into one or more different languages.

20. The system of claim 17 wherein the structured documents are patent documents, company annual reports, or financial reports.
